(19) United States
(12) Patent Application Publication
(10) Pub. No.: US 2012/0204988 A1
(43) Pub. Date: Aug. 16, 2012

(54) PLUMBING FITTING TO CONTROL PEST INFESTATIONS IN BUILDINGS, ESPECIALLY TERMITES

(76) Inventor: Stephen Graham Russell, Aitkenvale (AU)

(21) Appl. No.: 13/503,469

(22) PCT Filed: Oct. 22, 2010
(86) PCT No.: PCT/AU2010/001415

§ 371 Date: Apr. 23, 2012

(30) Foreign Application Priority Data
Oct. 27, 2009 (AU) 2009230785

(51) Int. Cl. F16L 55/10; F16L 39/00

(52) U.S. Cl. 138/89; 285/122.1

(57) ABSTRACT

A plumbing fitting (60) comprising an elongate sleeve (61) that allows a conduit (eg a drain) (63) to pass longitudinally there through such that a cavity (66) is formed between the conduit and the sleeve. The sleeve is attached to the floor or slab at the base and also forms a seal against the conduit at the other end. There is provided an access opening (68) in the side wall of the sleeve, giving access to the interior space between the sleeve and the conduit. In use, a pesticide (67) may be poured or injected into the cavity (66).

### FIELD OF THE INVENTION

The present invention relates to a fitting. In particular, the present invention relates to a plumbing fitting that can be used to control pest infestations in buildings.

### BACKGROUND ART

Infestations of pests, such as termites (also known as “white ants”), can lead to serious structural damage to buildings. As a result, many attempts have been made to try to prevent pest infestations in buildings such as domestic dwellings.

However, some points of entry into buildings used by pests are extremely difficult to seal effectively over long periods of time. For instance, pests may find their way into a building through openings that develop over time between a concrete slab and plumbing lines due to movement of the slab and the subsequent separation of the plumbing lines from the slab.

When infestations occur under these circumstances, treatment of the infestation is both difficult due to the inaccessibility of the point of entry of the pests, and also expensive due to the effort required to gain access to the entry point and to repair any damage caused in doing so.

Therefore, there would be an advantage if it were possible to provide a fitting that assisted in reducing the prevalence of pest infestations in buildings, by both physically preventing pests from gaining entry to a building and providing a simple and cost-effective means of treating any such infestations before the pests gain entry to the building.

It will be clearly understood that, if a prior art publication is referred to herein, this reference does not constitute an admission that the publication forms part of the common general knowledge in the art in Australia or in any other country.

Throughout this specification, the term “comprising” and its grammatical equivalents shall be taken to have an inclusive meaning unless the context of use indicates otherwise.

### OBJECT OF THE INVENTION

It is an object of the present invention to provide a fitting which may overcome at least some of the abovementioned disadvantages, or provide a useful or commercial choice.

In one aspect, the invention resides broadly in a fitting comprising an elongate body adapted to allow a conduit to pass at least partially therethrough, the fitting further comprising one or more apertures in a side wall thereof adapted to provide access to the interior of the fitting.

In a preferred embodiment of the invention, the opposed ends of the elongate body are open.

Preferably, the conduit passes entirely through the elongate body of the fitting. Normally the fitting receives a portion of the conduit concentrically. Preferably, the diameter of the conduit is less than that of the fitting such that a cavity is formed between an outer wall of the conduit and an inner wall of the fitting.

The fitting may be of any suitable size, shape and configuration. Indeed, it is envisaged that the size of the fitting may change depending on the size of the conduit to be passed therethrough. However, in a preferred embodiment of the invention, at least one end of the fitting is provided with a narrowed region such that a seal may be formed between the at least one end and the conduit. The seal may be formed at or adjacent the first end. The seal may be formed using any suitable technique, such as, but not limited to, creating a friction seal between the conduit and the fitting, locating sealing means (such as a gasket, O-ring or the like) between the narrowed region of the fitting and the conduit, providing the conduit and the narrowed region of the fitting with mating screw threads or the like, or using a suitable chemical sealant, such as, but not limited to, glue or the like.

The narrowed region may be formed integrally with the elongate body of the fitting. Alternatively, the narrowed region may be formed separately from the elongate body and adapted for connection thereto. In this embodiment of the invention, the narrowed region may be adapted for connection to the elongate body using any suitable technique. For instance, the narrowed region may be connected to the elongate body via complementary screw-threaded portions. Alternatively, the narrowed region may be connected to the elongate body by welding, brazing, soldering or the like. In other embodiments, the narrowed portion and the elongate body may be connected using a frictional engagement. Still further, the narrowed region and the elongate body may be connected using fastening means such as screws, bolts, nails, rivets or the like, or an adhesive such as a glue.

In embodiments of the invention in which the ends of the elongate body are open, it is preferred that the narrowed region is provided with capping means for capping the open first end of the elongate body. Any suitable capping means may be provided, and the capping means may be formed integrally with the elongate body or may be formed separately and connected thereto. The capping means may engage with the elongate body using any suitable technique, such as, but not limited to, using fastening means, adhesives, or complementary screw-threaded portions. Preferably, the capping means forms a seal against the elongate body and abuts the conduit at the point at which the conduit exits the fitting through the first end. In some embodiments, the capping means may be adapted to seal against the conduit at the point at which the conduit exits the fitting through the first end.

In a preferred embodiment of the invention, it is envisaged that a second end of the elongate body may be connected to a support during use. The second end may be connected to any suitable support, such as, but not limited to, flooring or a concrete slab. In some embodiments of the invention, the second end may be adapted to be at least partially buried in soil, sand or the like. In this embodiment of the invention, the second end may be provided with dispersal means to assist in dispersing any material (such as a fluid) inside the fitting over a wider area. The dispersal means may be of any suitable form, although in some embodiments of the invention, the fitting may be provided with one or more apertures in the elongate body adjacent the second end such that material inside the fitting may escape into the soil, sand or the like both through the wall of the elongate body and through the open second end of the fitting. Alternatively, a mesh, waste or the like or any other suitable attachment comprising one or more openings may be adapted for connection to the second end of the fitting. In this way, if a pesticide is poured into the fitting, the pesticide may be dispersed into the soil, sand or the like over a greater area, thereby providing more effective protection from pests.

By connecting the fitting to a support and not the conduit, the fitting will move with the movement of the support (for instance, the concrete slab) over time. This ensures that points of entry into the building for pest infestations are not created, as gaps will not form between the fitting and the support that create openings through which pests may enter the building.

The second end may be connected to a support using any suitable technique. However, it is preferred that the second end is connected to the support such that a seal is formed between the support and the fitting. For instance, the second end may be adapted for connection to a concrete slab using a sealant, glue or the like. Alternatively, the second end of the fitting may be provided with sealing means that seal against one side of a concrete slab. In this embodiment of the invention, the sealing means may comprise one or more flanges adapted to abut and substantially seal against the lower face of a concrete slab.

In a preferred embodiment, the second end may be adapted for connection to a support using both sealing means (such as a gasket, O-ring or the like) as well as a chemical sealant or adhesive.

In some embodiments of the invention, the fitting may comprise a plurality of spaced apart sealing means. For instance, the second end of the fitting may be provided with a first sealing means for sealing against a lower face of the concrete slab, while a second sealing means may be provided spaced apart from the first sealing means for sealing against an upper face of the concrete slab. Further sealing means may be provided as desired. The sealing means may be formed integrally with the elongate body of the fitting or may be formed separately and adapted for connection thereto. In some embodiment of the invention, a sealing portion including the sealing means may be formed separately from the elongate body and may be adapted for removable or fixed attachment to thereto. For instance, the sealing portion may be adapted for screw-threaded or frictional connection to the elongate body, although it is envisaged that any suitable technique could be used to connect the sealing portion to the elongate body. In some embodiments of the invention, the sealing means may also serve a secondary purpose as locking means such that the fitting is simultaneously sealed against the concrete slab and locked in place.

In some embodiments of the invention, the second end may further be provided with engagement means adapted to engage with the conduit passing through the fitting. The engagement means may be of any suitable form, although in a preferred embodiment of the invention, the engagement means comprise one or more projections adapted to provide a frictional engagement with an outer surface of the conduit. The engagement means may further comprise termite mesh.

The apertures may be of any suitable size, shape or configuration. However, in a preferred embodiment of the invention, the one or more apertures are provided at a point that is accessible to a user. Thus, it is preferred that the one or more apertures are located at a point on the fitting that is above the floor line of the building.

In some embodiments, the apertures may simply be apertures in the wall of the fitting. In alternative embodiments of the invention, the apertures may be in the form of an access port that extends outwardly from the wall of the elongate body. In this embodiment of the invention, the access port may be in the form of a tube extending outwardly from the elongate body. The access ports may be formed integrally with the fitting, or may be formed separately and adapted for connection thereto.

The one or more access ports are adapted to allow a user to gain access to the interior of the fitting for, for instance, visual inspection to determine the presence of pest infestations, or to treat an existing pest infestation by applying pesticides through the access ports. In this way, even a pest infestation located below a concrete slab may be quickly and easily treated.

In a preferred embodiment, the apertures or access ports are covered when not in use so as to cover the open apertures or access ports and prevent pests from exiting the fitting through the apertures or access ports. Any suitable covering means may be used, such as, but not limited to, a cap or the like adapted to be placed either over the apertures or over the end of the access ports. In embodiments of the invention in which access ports are present, the covering means and the access ports may be provided with complementary screw threaded portions to ensure that the covering means is not accidentally removed. Alternatively, the covering means may be adapted for a frictional engagement with the access port to prevent its unwanted removal. In other embodiments of the invention, the covering means may simply be adapted to cover the open end of the access port.

In embodiments of the invention in which the covering means comprises a cap (or similar device), it is preferred that the covering means is provided with a non-opaque portion that allows a visual inspection of the interior of the fitting when the covering means is in place. For instance, the covering means may be provided with a window portion. In some embodiments of the invention, the non-opaque portion may be provided with one or more apertures therein, such as for ventilation purposes. In this embodiment of the invention, the window portion will allow a user to determine instantaneously whether any pests are present. For instance, the presence of dirt, soil or mud on the window portion will immediately alert a user to pest activity and indicate that treatment (such as the use of a pesticide) is required.

Any suitable conduit may be used, although it is envisaged that the conduit may comprise a plumbing line, such as a water line, sewage pipe or the like. Alternatively, the conduit may be in the form of a services conduit, such as one carrying electrical cables, telephone wires, fibre optic cables or the like, or any combination thereof.

In another aspect, the invention resides broadly in a fitting comprising an elongate body adapted to allow a conduit to pass at least partially therethrough, the fitting having a narrowed region at one end thereof adapted to form a seal with the conduit, the fitting further comprising one or more access ports in a side wall thereof adapted to provide access to the interior of the fitting.

In a further aspect, the invention resides broadly in a fitting comprising an elongate body adapted to allow a conduit to pass at least partially therethrough, the fitting having a narrowed region at a first end thereof adapted to form a seal with the conduit, and engagement means at a second end thereof adapted to engage the conduit, the fitting further comprising one or more access ports in a side wall thereof adapted to provide access to the interior of the fitting.

### BRIEF DESCRIPTION OF THE DRAWINGS

An embodiment of the invention will be described with reference to the following drawings in which:

FIG. 1 illustrates a side cross-sectional view of a fitting according to an embodiment of the present invention;

FIG. 2 illustrates a side cross-sectional view of a fitting according to an alternative embodiment of the present invention;

FIG. 3 illustrates a perspective view of a fitting according to an embodiment of the present invention;

FIG. 4 illustrates a perspective view of a fitting according to an embodiment of the present invention;

FIG. 5 illustrates a detailed perspective view of an access port according to an embodiment of the present invention;

FIG. 6 illustrates a cross-sectional view of a fitting according to an embodiment of the invention when in use;

FIGS. 7-10 illustrate steps in the installation of a fitting according to an embodiment of the present invention;

FIG. 11 illustrates a cross-sectional view of a fitting according to an embodiment of the present invention; and

FIG. 12 illustrates a cross-sectional view of a fitting according to an embodiment of the invention when in use.

### DETAILED DESCRIPTION OF THE DRAWINGS

It will be appreciated that the drawings have been provided for the purposes of illustrating preferred embodiments of the present invention and that the invention should not be considered to be limited solely to the features as shown in the drawings.

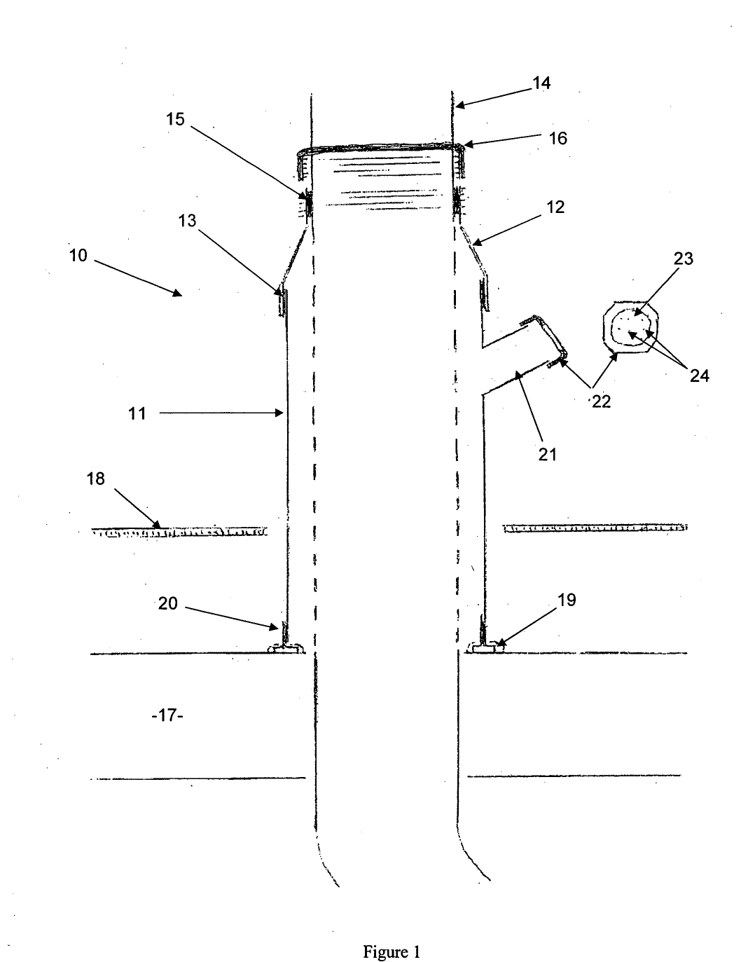

In FIG. 1 there is shown a side cross-sectional view of a fitting 10 according to an embodiment of the present invention. The fitting 10 comprises an elongate body 11 and a narrowed region 12 at a first end thereof. In the embodiment of the invention illustrated in FIG. 1, the narrowed region 12 is formed separately from the elongate body 11 and is attached thereto using an adhesive 13. The narrowed region 12 seals against the conduit 14 adjacent the first end via a Teflon seal 15 positioned between the narrowed region 12 and the conduit 14.

The first end of the fitting 10 is further provided with capping means in the form of a cap 16 adapted for screw-threaded engagement with the narrowed region 12. The upper surface of the cap 16 is provided with an opening (obscured) through which the conduit 14 passes.

The second end of the fitting 10 is adapted for connection to a support in the form of a concrete slab 17 at a point below floor level 18 of the building. The second end is connected to the concrete slab 17 using a sealant 19 (such as Mastik). Sealing means 20 in the form of a gasket or the like are also provided at the second end.

In the embodiment of the invention illustrated in FIG. 1, the fitting 10 will move with the movement of the concrete slab 17 over time, meaning that the seal between the fitting 10 and the concrete slab 17 will not break and create openings through which pests may enter the building.

The fitting 10 further comprises an access port 21 extending outwardly from the surface of the elongate body 11. The access port 21 is provided at a point above floor level 18 so that a user may readily gain access to the access port 21.

When not in use, the access port 21 is provided with covering means in the form of a cap 22 adapted for frictional engagement with the open end of the access port 21. The cap 22 is provided with a window 23 to allow for visual inspection of the interior of the fitting 10 through the access port 21 without requiring the cap 22 to be removed. The window 23 is provided with a plurality of holes 24, such as for ventilation.

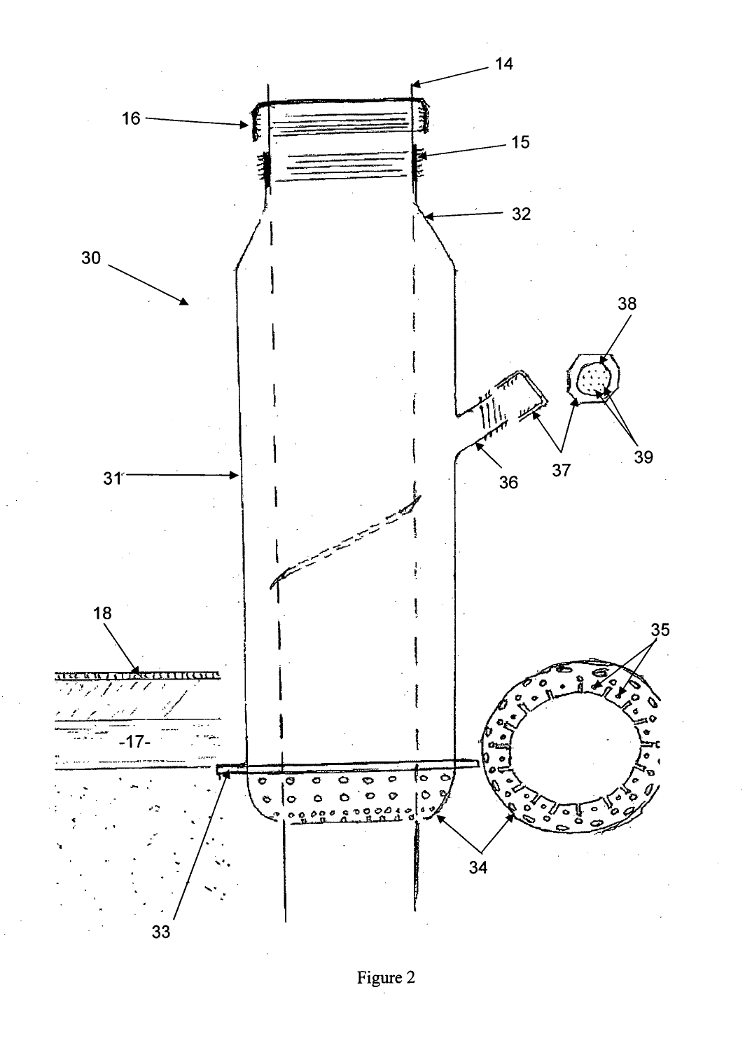

In FIG. 2, a side cross-sectional view of a fitting 30 according to an alternative embodiment of the present invention is shown. The fitting 30 comprises an elongate body 31 with a narrowed region 32 at one end, the narrowed portion 32 being formed integrally with the elongate body 31. A portion of conduit 14 passes through the opposed open ends of the fitting 30 such that the fitting is positioned concentrically about a portion of the conduit. The narrowed region 32 seals against the conduit 14 adjacent the first end via a Teflon seal 15 positioned between the narrowed region 32 and the conduit 14.

The first end of the fitting 30 is further provided with capping means in the form of a cap 16 adapted for screw-threaded engagement with the narrowed region 32. The upper surface of the cap 16 is provided with an opening (obscured) through which the conduit 14 passes.

The second end of the fitting 30 is adapted for connection to a support in the form of a concrete slab 17 at a point below floor level 18 of the building. The second end is sealed against the lower face of the concrete slab 17 using sealing means in the form of an annular flange 33 adjacent the second end of the fitting 30.

In the embodiment of the invention illustrated in FIG. 2, the fitting 30 will move with the movement of the concrete slab 17 over time, meaning that the seal between the fitting 30 and the concrete slab 17 will not break and create openings through which pests may enter the building.

The second end of the fitting 30 is further provided with engagement means 34 in the form of termite mesh comprising a plurality of teeth 35 adapted to engage with the outer surface of the conduit 14.

The fitting 30 further comprises an access port 36 extending outwardly from the surface of the elongate body 31. The access port 36 is provided at a point above floor level 18 so that a user may readily gain access to the access port 36.

When not in use, the access port 36 is provided with covering means in the form of a cap 37 adapted for screw-threaded engagement with the open end of the access port 36. The cap 37 is provided with a window 38 to allow for visual inspection of the interior of the fitting 30 through the access port 36 without requiring the cap 37 to be removed. The window 38 is provided with a plurality of holes 39, such as for ventilation.

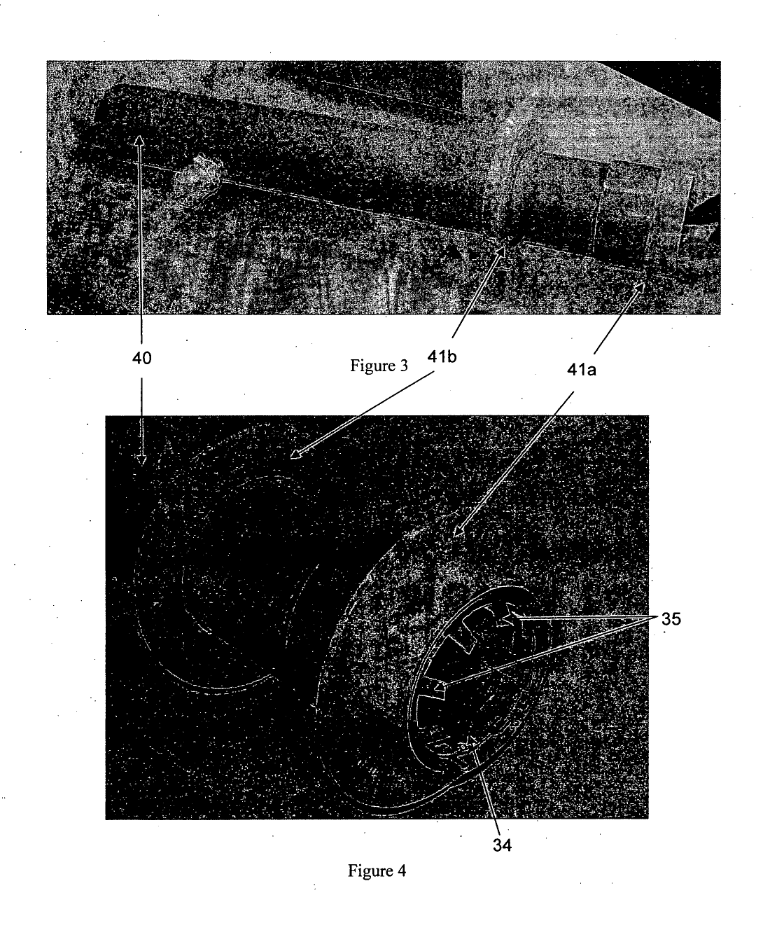

In FIGS. 3 and 4, perspective views of a fitting 40 according to an alternative embodiment of the invention are shown. In these Figures, the fitting 40 comprises a pair of sealing means in the form of spaced apart flanges 41a, 41b. Flange 41a is adapted to seal against the lower face of a concrete slab (not shown) while flange 42b is adapted to seal against an upper surface of the concrete slab (not shown). The flanges 41a, 41b may also serve to lock the fitting 40 in place against the concrete slab (not shown).

In FIG. 4 it may be seen that the engagement means 34 is provided with a plurality of teeth 35 adapted to engage with the outer surface of a conduit (not shown).

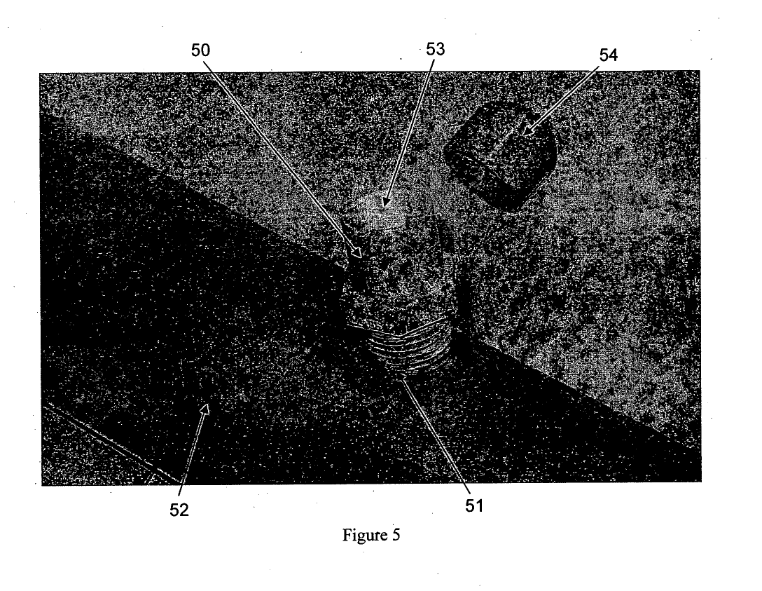

In FIG. 5, a detailed perspective view of an access port 50 according to an embodiment of the invention is shown. The access port 50 is adapted for screw-threaded engagement with an opening 51 in the surface of the elongate body 52. The access port 50 has an open end 53 which, when not in use, may be covered by a cap 54 adapted for frictional engagement with the access port 50.

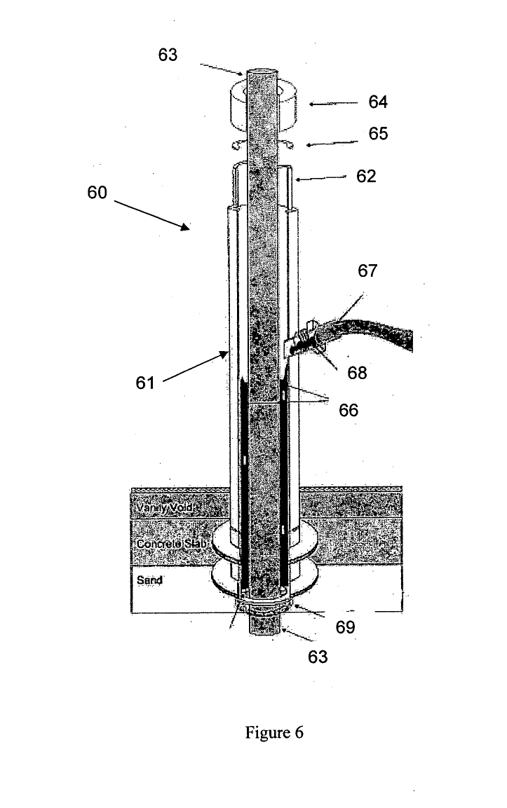

Turning now to FIG. 6 there is shown a cross-sectional view of a fitting 60 according to an embodiment of the present invention when in use. The fitting 60 comprises an elongate body 61 with a narrowed region 62 at a first end thereof. A conduit 63 passes through the fitting 60 such that a cavity 66 is formed between the outer surface of the conduit 63 and the inner surface of the fitting 60.

The first end is provided with a cap 64 for covering the open first end of the fitting 60 and a Teflon seal 65 that is located between the conduit 63 and the inner surface of the narrowed region 62 so as to form a seal therebetween.

The second end of the fitting 60 is provided with mesh 69 to assist in preventing pests such as termites from gaining access to the building.

In use, a pesticide 67 is injected or poured into the cavity 66 through the access port 68. This can be done periodically as a preventative measure, or it may be done at times when a pest infestation has occurred in order to kill the pests before they have a chance to gain entry to the building.

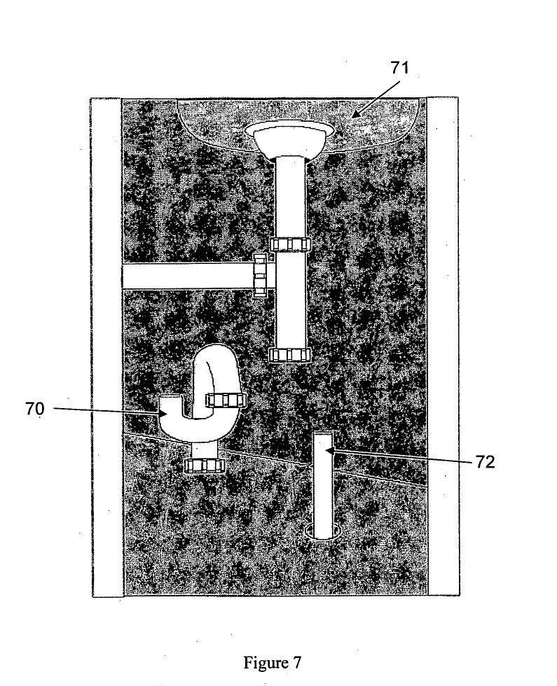

In FIGS. 7 to 10, the steps in the installation of a fitting 60 according to an embodiment of the invention are illustrated. In FIG. 7, the S-bend 70 below a basin 71 is disconnected, leaving a pipe 72 exposed.

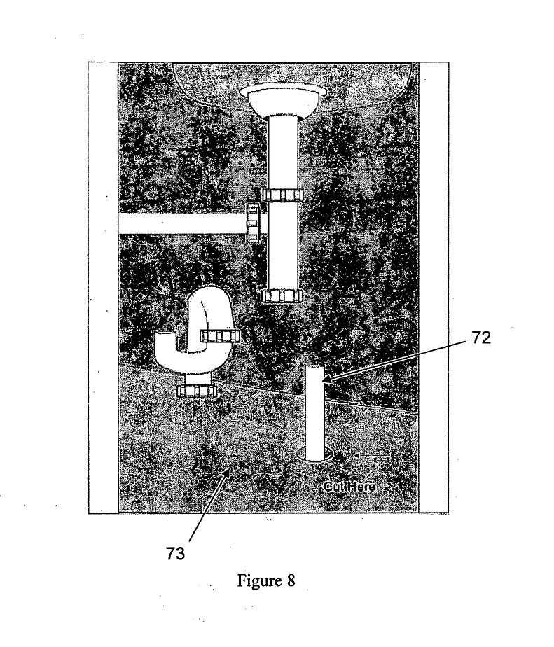

In FIG. 8, the section of floor 73 around the pipe 72 is cut to make space for the fitting 60.

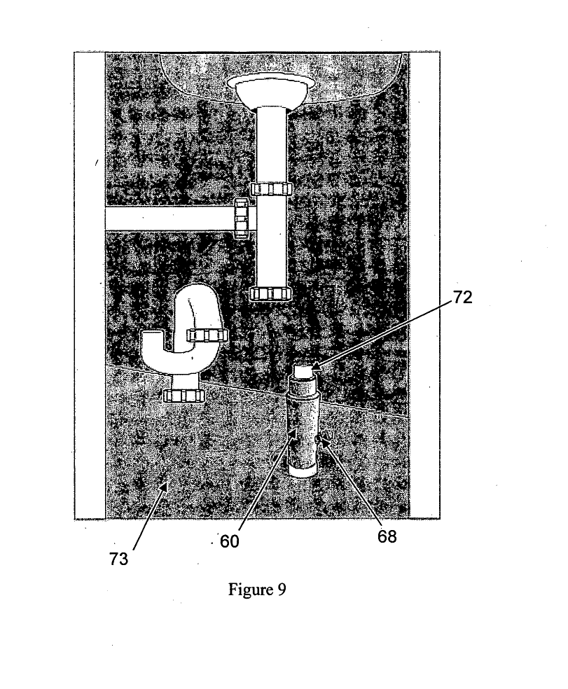

In FIG. 9, the fitting 60 is placed over the pipe 72, ensuring that the access port 68 is located above floor level 73.

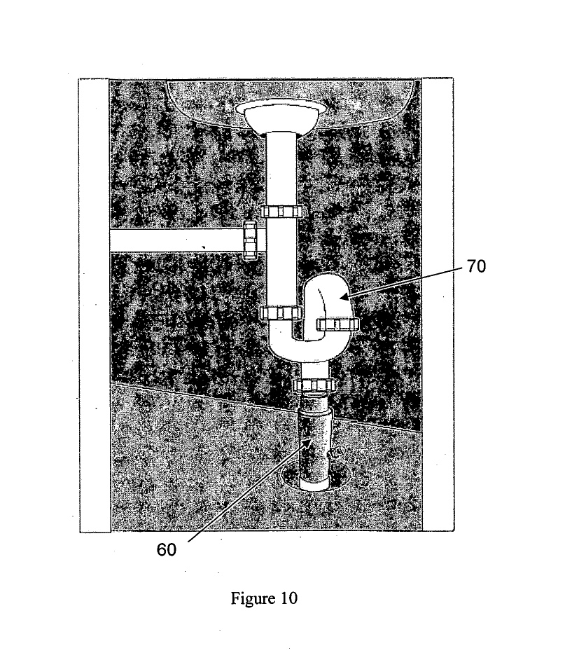

In FIG. 10, the S-bend 70 is reinstalled-above the fitting 60.

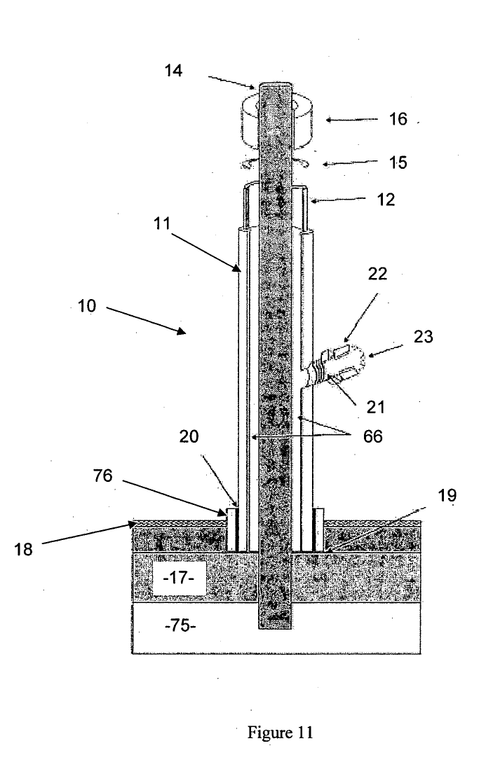

In FIG. 11, a cross-sectional view of a fitting 10 according to an embodiment of the present invention is shown. The fitting 10 of FIG. 11 is very similar to that illustrated in FIG. 1, with only a few differences. As in FIG. 1, the fitting 10 comprises an elongate body 11 through which a conduit 14 passes. The fitting comprises a narrowed region 12 at a first end thereof. In the embodiment of the invention illustrated in FIG. 11, the narrowed region 12 is formed integrally with the elongate body 11, although it is envisaged that the narrowed region 12 could be formed separately from the elongate body 11 and adapted for frictional engagement with the elongate body by sliding the narrowed region 12 into the open end of the elongate body 11. The fitting 10 is provided with a cap 16 for covering the open first end of the fitting 10. In FIG. 11, the cap 16 is adapted for frictional engagement with the narrowed region 12. The fitting 10 is further provided with a Teflon seal 15 adapted to create a seal between the outer surface of the narrowed region 12 and the inner surface of the cap 16.

The diameter of the elongate body 11 is larger than that of the conduit 14 such that a cavity 66 is formed between the conduit 14 and the inner surface of the elongate body 11.

The second end of the fitting 10 extends below floor level 18 and is sealed against the upper surface of a concrete slab 17 using a sealant 19 such as Mastik. A seal 20 is provided at the second end, the seal 20 being located between the outer surface of the elongate body 11 and the inner surface of a sleeve 76.

An access port 21 is provided on the fitting 10, the access port 21 being connected to the elongate body 11 via a screw thread. The access port 21 has a cap 22 with a clear window portion 23 therein.

The conduit 14 passes through the concrete slab 17 and terminates in a layer of sand 75 located below the concrete slab 17.

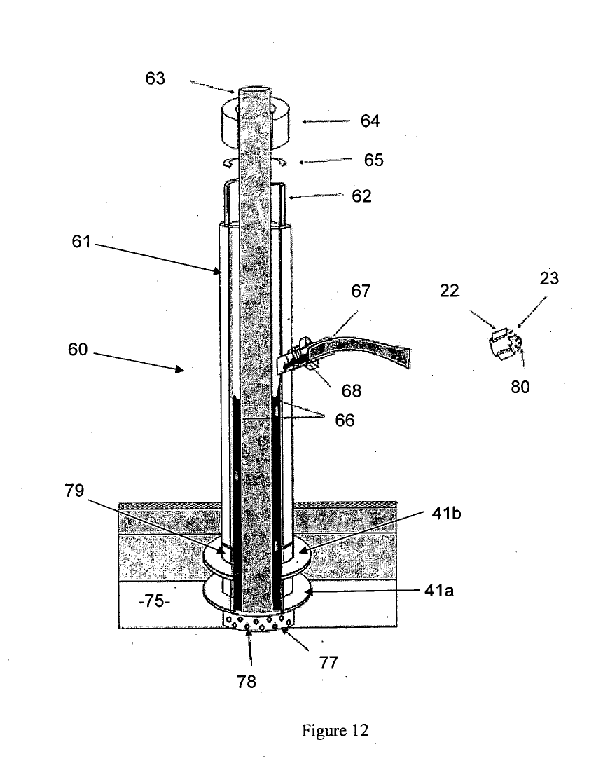

In FIG. 12, a cross-sectional view of a fitting 60 according to an embodiment of the present invention is shown. The fitting 60 illustrated in FIG. 12 is very similar to that illustrated in FIG. 6 with a few notable differences.

The fitting 60 comprises an elongate body 61 with a narrowed region 62 at a first end thereof. A conduit 63 passes through the fitting 60 such that a cavity 66 is formed between the outer surface of the conduit 63 and the inner surface of the fitting 60.

The first end is provided with a cap 64 for covering the open first end of the fitting 60 and a Teflon seal 65 that is located between the conduit 63 and the inner surface of the narrowed region 62 so as to form a seal therebetween.

In use, a pesticide 67 is injected or poured into the cavity 66 through the access port 68. This can be done periodically as a preventative measure, or it may be done at times when a pest infestation has occurred in order to kill the pests before they have a chance to gain entry to the building.

The second end of the fitting 60 is provided with waste 77 comprising a plurality of apertures 78. The pesticide 67 passes downwardly through the fitting 60 and is dispersed into a sand layer 75 both through the open second end of the fitting 60 and through the apertures 78 in the waste 77 so as to treat a larger area of the sand 75.

In FIG. 12 it may be seen that the fitting 60 comprises a sealing portion 79 at the lower end thereof. The sealing portion 79 comprises the pair of flanges 41a, 41b and is adapted for connection to the elongate body 61 via frictional engagement.

The fitting 60 further comprises a cap 22 for covering the access port 68. The cap 22 comprises a transparent window portion 23. In FIG. 12, the interior of the window portion 23 is shown covered in mud 80 indicating to a user that there has been termite activity. The presence of mud 80 should then indicate to a user that use of a pesticide 67 is required.

Those skilled in the art will appreciate that the present invention may be susceptible to variations and modifications other than those specifically described. It will be understood that the present invention encompasses all such variations and modifications that fall within its spirit and scope.

1. A fitting comprising an elongate body adapted to allow a conduit to pass at least partially therethrough, the fitting further comprising one or more apertures in a side wall thereof adapted to provide access to the interior of the fitting.

2. A fitting according to claim 1 wherein opposed ends of the elongate body are open.

3. A fitting according to claim 1 wherein a first end of the elongate body comprises a narrowed region.

4. A fitting according to claim 3 wherein a seal is formed between the narrowed region and the conduit.

5. A fitting according to claim 3 wherein the narrowed region is provided with capping means for capping the first end of the elongate body.

6. A fitting according to claim 3 wherein a second end of the elongate body is adapted for connection to a support.

7. A fitting according to claim 6 wherein the second end is provided with one or more sealing means adapted to seal against the support.

8. A fitting according to claim 7 wherein the second end further comprises engagement means adapted to engage with the conduit.

9. A fitting according to claim 1 wherein the one or more apertures are access ports.

10. A fitting according to claim 9 wherein the access ports comprise a tube extending outwardly from the elongate body.

11. A fitting according to claim 9 wherein the access ports are provided with covering means to cover the access ports when not in use.

12. A fitting according to claim 11 wherein the covering means are provided with a non-opaque portion to facilitate visual inspection of the interior of the fitting when the covering means is in place.

13. A fitting comprising an elongate body adapted to allow a conduit to pass at least partially therethrough, the fitting having a narrowed region at one end thereof adapted to form a seal with the conduit, the fitting further comprising one or more access ports in a side wall thereof adapted to provide access to the interior of the fitting.

14. A fitting comprising an elongate body adapted to allow a conduit to pass at least partially therethrough, the fitting having a narrowed region at a first end thereof adapted to form a seal with the conduit, and engagement means at a second end thereof adapted to engage the conduit, the fitting further comprising one or more access ports in a side wall thereof adapted to provide access to the interior of the fitting.
